(19) United States
(12) Patent Application Publication
(10) Pub. No.: US 2020/0121089 A1
(43) Pub. Date: Apr. 23, 2020

(54) TORSO SUPPORT CHAIR

(71) Applicants: Deborah June Mary Rucci, North Vancouver (CA); Nuncio John Claudio Rucci, North Vancouver (CA)

(72) Inventors: Deborah June Mary Rucci, North Vancouver (CA); Nuncio John Claudio Rucci, North Vancouver (CA)

(21) Appl. No.: 16/166,106

(22) Filed: Oct. 21, 2018

(51) Int. Cl. A47C 9/02; A47C 7/54; A47C 9/00; A61G 15/00

(52) U.S. Cl. CPC A47C 9/025; A61G 15/00; A47C 9/002; A47C 7/541

(57) ABSTRACT

A torso supporting chair having a chair and front support. The chair has a seat support and at least one leg. The seat support having a top side and a bottom side, with the at least one leg attached to the bottom side. A front support is in functional combination the chair and may be integrally mounted with the at least one leg such that the front support is configured for seating of a user such that when the user is seated the chest of the user is adjacent and facing the front support. The torso support chair is configured to support the front torso of a user when seated.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of chairs and seats of existing art and more specifically relates to a torso support chair.

### BACKGROUND

Dentistry is a branch of medicine that consists of the study, diagnosis, prevention, and treatment of diseases, disorders, and conditions of the oral cavity. During dental procedures the dental hygienist or dentist is often sitting facing the patient and leaning forward. Generally, chairs used may not be optimal for comfort or efficiency during dental procedures and similar activities which require leaning forward. In many cases, a rotating stool is used which offers no support at all. Additionally, there is a need to access dental equipment during dental procedure, and it would be preferably if this could be made possible while continuing to support the user in the chair. A suitable solution is desired.

U.S. Pat. No. 6,619,747 to Kam Ko and Kay K. Lau relates to torso and forearm supporting device for chairs and work stands. The described torso and forearm supporting device for chairs and work stands include a torso and forearm support which is provided for supporting the body of a user resting in a seated or standing position with forearm supports for allowing the user to rest at least one forearm during forearm movement while continuously engaging the armrest. The forearm supports are individually adjustable vertically and rotatable to accommodate the dynamic and/or continuous movement of the user's arm(s). Articulated armrest brackets fold in a compact manner behind the post assembly for storage when not in use.

### SUMMARY OF THE INVENTION

In view of the foregoing disadvantages inherent in the known chairs and seats art, the present disclosure provides a novel torso support chair. The general purpose of the present disclosure, which will be described subsequently in greater detail, is to provide an efficient and effective torso support chair for use in dental procedures and similar activates where the user leans forward in a chair or stool and requires front torso support.

A torso support chair is disclosed herein having a chair and a torso support bar assembly. The chair includes a seat-support-member having a top-side, a bottom-side, and at least one leg. The torso support chair assembly has a front-support that is integrally mounted with the chair such that the front-support is configured for seating of a user-occupant such that when the user-occupant is seated a chest of the user-occupant is adjacent and facing the front-support (for front torso support). As designed, the seat-support-member is intended for receiving the user-occupant entering from a rear-side (alternately from a side position). The torso support chair is configured for efficient use in dental procedures.

Alternatively, the torso support chair may be provided as detachable from the leg of the chair to add front torso support to an existing chair or stool.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a torso support chair, constructed and operative according to the teachings of the present disclosure.

FIG. 1 is a perspective view of an embodiment of the torso support chair during an ‘in-use’ condition, of the invention.

FIG. 2 is a side view of an embodiment of the torso support chair torso support chair, of the present invention.

FIG. 3 is a front view of an embodiment of the torso support chair of the present invention.

FIG. 4 is a back view of an embodiment of the torso support chair of the present invention.

FIG. 5 is a top view of an embodiment of the torso support chair of the present invention.

FIG. 6A is an embodiment of the torso support bars of the present invention.

FIG. 6B is an additional embodiment of the torso support bars of the present invention.

FIG. 6C is an additional embodiment of the torso support bars of the present invention.

FIG. 7 is a top view of an embodiment of the support arm of the present invention.

FIG. 8 is a top view of an additional embodiment of the torso support chair of the present invention.

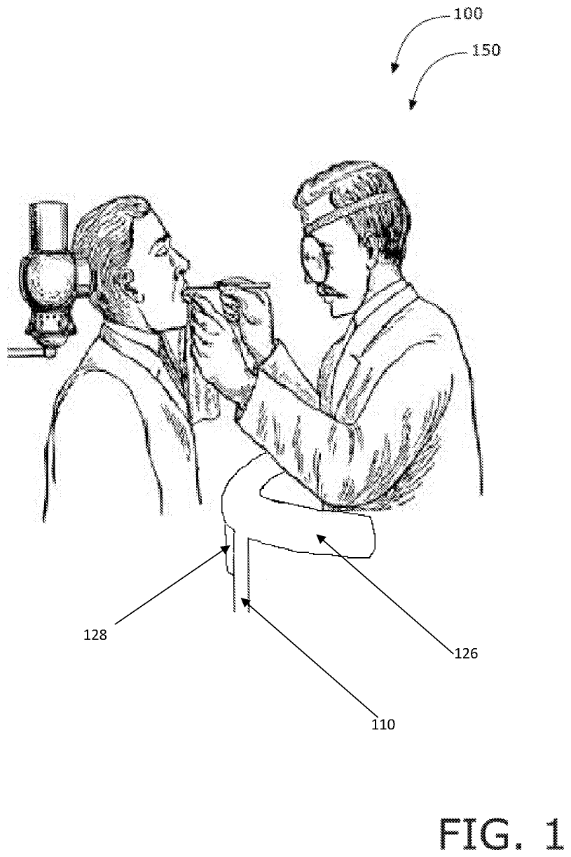

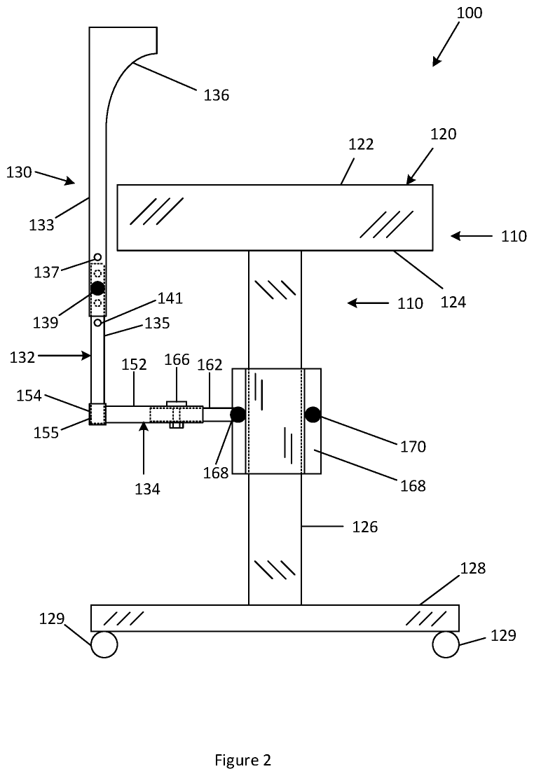

### DETAILED DESCRIPTION

As discussed above, embodiments of the present disclosure relate to a chairs and seats and more particularly to a torso support chair as used to improve the comfort of dental hygienists and dentist and other who perform activities that require front torso support.

Generally, a torso support chair is disclosed. The torso support chair comprises chair in combination with a front support. The present invention may be used on any single pedestal stool, either as a detachable arm or as a unitary piece. The front support gives front torso support instead of leaning sideways which is desirable. This present invention is a variation to any dental assisting arm rest presently available. This design offers full front torso support while providing an arm rest for the user increasing support comfort and maneuverability.

As illustrated in the figures, a torso support chair 100 during an ‘in-use’ condition 150, according to an embodiment of the present invention is disclosed. Here, the torso support chair 100 may be beneficial for use by a user to promote comfort and efficiency in dental procedures. As illustrated, the torso support chair 100 may include a chair 110 in combination with a front support 130. The chair may include a seat support 120 having a top-side 122 and a bottom-side 124. and at least one leg 126 attached to the bottom-side 124. Top-side 122 is configured to accommodate a person in a seated position. In this embodiment, seat support 120 is illustrated as a rotating, swivel-type of seat. This is illustrative and not meant to be limiting as other types of seats may be utilized. Further, in this embodiment, chair 110 has a base 128 attached to rollers 129 to allow chair 110 to be moved on a planar floor surface. Other embodiments may be stationary and mounted to the floor and don't move relative to the floor but may swivel for example.

The front support 130 is in functional combination the chair 110. The front support 130 is integrally mounted with the at least one leg 126 of chair 110 such that the front-support 130 is configured for seating of a user-occupant such that when the user-occupant is seated a chest of the user-occupant is adjacent and facing the front-support 130. As designed, chair 110 is intended for receiving the user-occupant entering from a rear-side (alternately from a side position), as such torso support chair 100 is configured for use in dental procedures. In this embodiment, the front support 130 is illustrated as a combination with chair 110. This is illustrative. Front support 130 may also be utilized as an attachment to an existing chair or stool.

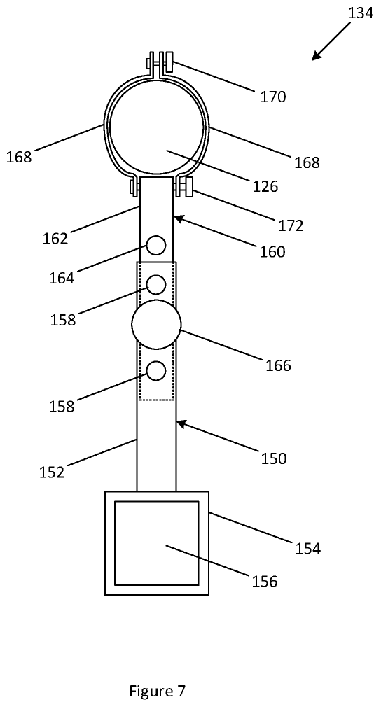

In this embodiment, front support 130 includes an adjustable support arm 134, see FIG. 7, to allow for adjustments forward/backward relation to the seat, to permit use by different sized users. Support arm 134 includes a receiver component 150 and a bracket component 160. Receiver component 150 includes a receiver arm 152 having a plurality of receiver arm adjustment holes 158 and a receiver 154 attached to one end thereof. Bracket component 160 includes a bracket arm 162 having a plurality of bracket arm adjustment holes 164. Bracket arm 162 is dimensioned to be slideably insertable inside receiver arm 152 and secured thereto by a support arm fastener 166. A two-piece bracket 168 is attached to one end of bracket arm 162 and configured to be secured around leg 126 by bracket fasteners 170. In operation, the user sets the desired forward/backward position of front support 130 by sliding bracket arm 162 within receiver arm 152 and utilizes support arm fastener 166 to secure the two arms together.

Further, in this embodiment, front support 130 includes an adjustable vertical arm 132 to allow for adjustments in height that is in communication with support arm 134. As illustrated, in this embodiment, receiver 154 includes an opening 156 that is dimensioned to receive vertical arm 130. Vertical arm includes a series of adjustment holes 157 to allow for height adjustment. In operation, the user sets the desired height of front support 130 within receiver 154 and utilizes a fastener 155 that is placed through on opening (not shown) in receiver 154 and the accompanying adjustment hole 157 to secure front support to receiver 154.

In this embodiment, fasteners 155, 166 and 170 are shown as bolts with locking knobs. This is illustrative and not meant to be limiting. Those skilled in the art will recognize that other fasteners may be utilized and are within the scope of the invention. Further, front support 130 is illustrated as having a separate support arm and vertical arm. This is illustrative and not meant to be limiting. Those skilled in the art will recognize that other configurations, i.e. a single, unitary support structure or a multiple-component support structure, may be utilized and is within the scope of the present invention.

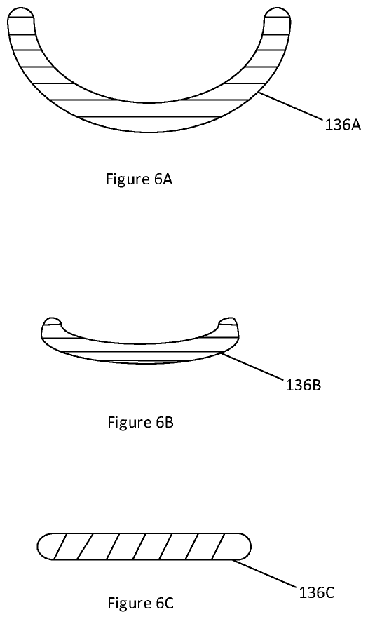

Additionally, front support may include a torso support bar 136 secured to vertical arm 132. Torso support bar 136 may be in a ridged or adjustable configuration. Further, as illustrated in FIGS. 6A-C, torso support bar 136 may be dimensioned in various configurations, such as a fully curved configuration 136A, a partial curved configuration 136B or a linear configuration 136C. These configurations are illustrative and not meant to be limiting. These variations of configurations allow to customization for personal preference and/or job performance requirements.

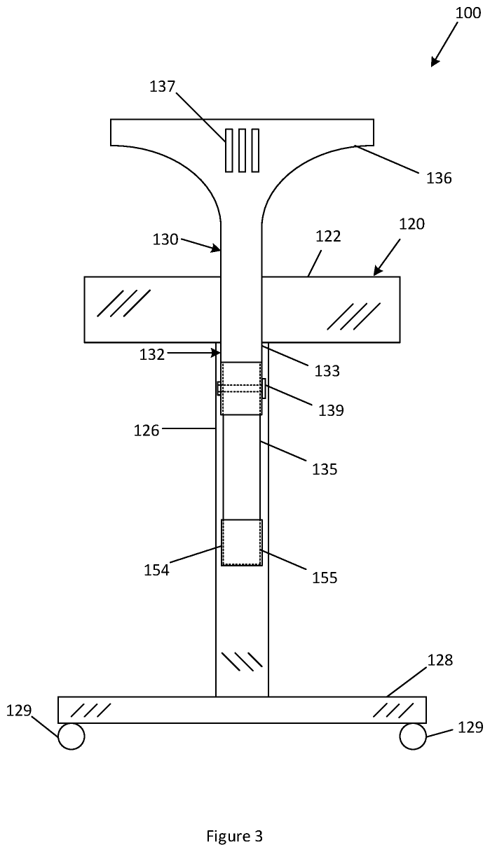

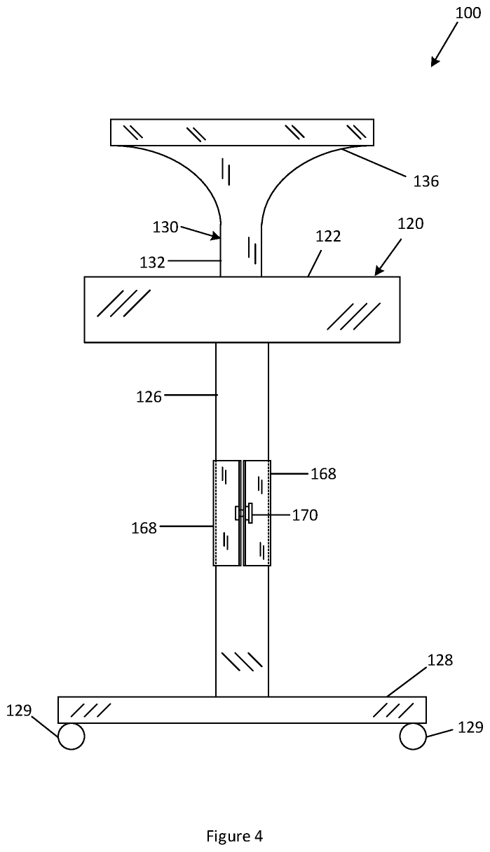

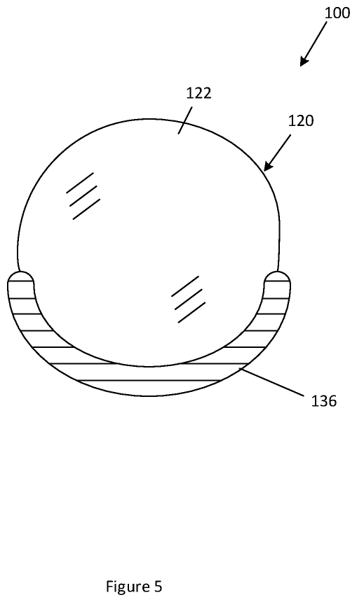

In some embodiments, as illustrated in FIG. 3, torso support bar 136 may include one or more mounts 137 for accessories or attachments. Mounts 137 may be located on the front side of torso support bar 136 for ready access to the hand of the user. For example, for use in dental hygiene or dentistry, a high-volume suction, a saliva ejector and an air/water syringe, and/or tools may be held by mounts 137. In this embodiment, three mounts 137 are shown. This is illustrative and not meant to be limiting.

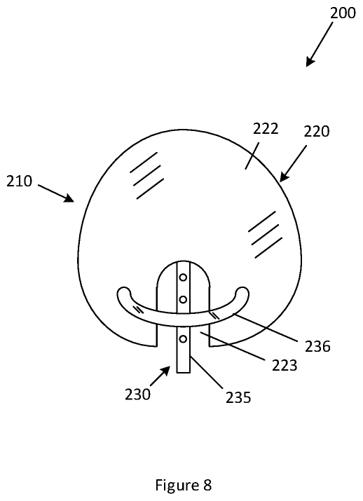

As illustrated in FIG. 8, an additional embodiment of torso support chair 200 is shown. As with the previously disclosed embodiment, torso support chair 200 may include a chair 210 in combination with a front support 230. Chair 210 may include a seat support 220 having a top-side 222. Seat support 220 have a recess 223 configured to allow front support 230 to be adjustable within the outer dimensions of seat support 220. This allows for additional adjustment capabilities for the user.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A torso supporting chair comprising:
a chair having a seat support and at least one leg, the seat support having a top side and a bottom side, the at least one leg secured to the bottom side; and
a front support mounted to the at least one leg such that the front support is configured for seating of a user such that when the user is seated the chest of the user is adjacent and facing the front support, the front support configured to support the torso of the user when seated.

2. The torso support chair of claim 1, wherein the chair further comprises a swivel base.

3. The torso support chair of claim 1, wherein the at least one leg comprises a single post.

4. The torso support chair of claim 1, wherein the front support comprises at least one mount for at least one accessory.

5. The torso support chair of claim 4, wherein the at least one mount is configured to receive dental equipment.

6. The torso support chair of claim 1, wherein the front support is removably detachable from the at least one leg.

7. The torso support chair of claim 1, wherein the front support is adjustable in height relative to the seat support.

8. The torso support chair of claim 1, wherein the front support is adjustable in distance relative from the seat support.

9. The torso support chair of claim 1, wherein the front support comprises;
a torso support bar; and
a support structure, the support structure being secured to the at least one leg of the chair and being secured to the torso support bar such that the torso support bar being located along a plane above the seat support.

10. A torso supporting apparatus for attachment to a chair having single post, the apparatus comprising:
a torso support bar; and
a support structure, the support structure being secured to the at least one leg of the chair and being secured to the torso support bar such that the torso support bar being located along a plane above the seat support.
